(19) United States
(12) Patent Application Publication
(10) Pub. No.: US 2026/0010395 A1
(43) Pub. Date: Jan. 8, 2026

(54) DATA PROCESSING METHOD, APPARATUS, AND SYSTEM BASED ON GPU ON-CHIP MEMORY

(71) Applicant: Alipay (Hangzhou) Information Technology Co., Ltd., Hangzhou (CN)

(72) Inventors: Changxu Shao, Hangzhou (CN); Kaihong Zhang, Hangzhou (CN); Junping Zhao, Hangzhou (CN)

(73) Assignee: Alipay (Hangzhou) Information Technology Co., Ltd., Hangzhou (CN)

(21) Appl. No.: 18/937,757

(22) Filed: Nov. 5, 2024

(30) Foreign Application Priority Data
Jul. 2, 2024 (CN) 202410881312.1

(51) Int. Cl. G06F 9/48; G06T 1/20

(52) U.S. Cl. CPC G06F 9/4881; G06T 1/20

(57) ABSTRACT

Methods, apparatuses, and systems for data processing based on graphics processing unit (GPU) on-chip memories are described. A data obtaining operation for first data is initiated on a first GPU thread. The first data include writable data needed by a GPU computing task. When the first GPU thread performs the data obtaining operation, a data preloading process of preloading second data from a GPU global memory to the GPU on-chip memory is initiated on a second GPU thread. The second data include read-only data that are needed by the GPU computing task and that are stored in the GPU global memory. The GPU computing task is executed on the second GPU thread based on the first data and the second data in response to that a data obtaining process of the first data and the data preloading process of the second data are completed.

### CROSS-REFERENCE TO RELATED APPLICATIONS

This application claims priority to Chinese Patent Application No. 202410881312.1, filed on Jul. 2, 2024, which is hereby incorporated by reference in its entirety.

### TECHNICAL FIELD

Embodiments of this specification generally relate to the field of data processing technologies, and in particular, to a data processing method, apparatus, and system based on a GPU on-chip memory.

### BACKGROUND

Conventional CPU hardware devices can hardly satisfy task computing needs of machine learning tasks or deep learning tasks, and in particular, can hardly satisfy model computing needs of generative large models exemplified by ChatGPT. Because of advantages such as a high-speed parallel processing capability and a stronger memory access bandwidth, the GPU hardware devices become mainstream acceleration hardware of model inference. However, in a large model inference phase, especially when batch data of model feature data for model inference are relatively small, a performance bottleneck of model inference is not model computing, but a data loading time of loading, from a GPU global memory to a GPU computing unit, model parameter data (model weight matrices) for model computing.

### SUMMARY

This specification embodiment provides data processing solutions based on GPU on-chip memories. In the data processing solution, a first GPU thread and a second GPU thread are enabled on a GPU device, and when the first GPU thread loads writable data needed by a GPU computing task, the second GPU thread preloads, to the GPU on-chip memory before executing the GPU computing task, read-only data that are used for the GPU computing task and that are stored in a GPU global memory, to reduce a data loading time when a GPU computing unit executes the GPU computing task, and improve data processing efficiency.

According to an aspect of the embodiments of this specification, a data processing method based on a GPU on-chip memory is provided, including: initiating a data obtaining operation for first data on a first GPU thread, where the first data include writable data needed by a GPU computing task; when the first GPU thread performs the data obtaining operation, initiating, on a second GPU thread, a data preloading process of preloading second data from a GPU global memory to the GPU on-chip memory, where the second data include read-only data that are needed by the GPU computing task and that are stored in the GPU global memory; and executing the GPU computing task on the second GPU thread based on the first data and the second data in response to that a data obtaining process of the first data and the data preloading process of the second data are completed.

Optionally, in an example of the above-mentioned aspect, the data processing method further includes: determining, based on a preloading configuration file, whether to initiate the data preloading process of preloading the second data from the GPU global memory to the GPU on-chip memory.

Optionally, in an example of the above-mentioned aspect, the GPU on-chip memory includes an L2 cache; and the initiating, on a second GPU thread, a data preloading process of preloading second data from a GPU global memory to the GPU on-chip memory includes: initiating, on the second GPU thread, a first data preloading process of preloading the second data from the GPU global memory to the L2 cache.

Optionally, in an example of the above-mentioned aspect, the GPU on-chip memory further includes a GPU shared memory and a GPU register, and the initiating, on a second GPU thread, a data preloading process of preloading second data from a GPU global memory to the GPU on-chip memory further includes: when data preloaded in the first data preloading process are a part of the second data, initiating, on the second GPU thread, a second data preloading process of preloading remaining data from the GPU global memory to the GPU shared memory and/or the GPU register.

Optionally, in an example of the above-mentioned aspect, the GPU on-chip memory further includes a GPU shared memory and a GPU register, and the initiating, on a second GPU thread, a data preloading process of preloading second data from a GPU global memory to the GPU on-chip memory further includes: when the first data preloading process does not need to be executed, initiating, on the second GPU thread, a third data preloading process of preloading the second data from the GPU global memory to the GPU shared memory and/or the GPU register.

Optionally, in an example of the above-mentioned aspect, data stored in the L2 cache are cached in a form of a sector, and each sector has an eviction priority.

Optionally, in an example of the above-mentioned aspect, the eviction priority includes one of evict_first, evict_normal, or evict_last, and the data processing method further includes: after the second data are preloaded to the L2 cache, setting, to evict_last, an eviction priority of a sector that caches the second data.

Optionally, in an example of the above-mentioned aspect, the data processing method further includes: when the second data are preloaded to the L2 cache, if free cache space of the L2 cache is insufficient to cache the second data, evicting sectors cached in the L2 cache based on eviction priorities of evict_first, evict_normal, and evict_last, until the free cache space of the L2 cache is sufficient to cache the preloaded second data.

Optionally, in an example of the above-mentioned aspect, the GPU computing task includes a model computing task of a model inference process, the first data include model feature data, and the second data include model parameter data.

Optionally, in an example of the above-mentioned aspect, a GPU computing lock is allocated for the GPU computing task, and the data processing method further includes: occupying the GPU computing lock on the first GPU thread during data obtaining of the first data, and releasing the GPU computing lock on the first GPU thread after data obtaining of the first data is completed; and the executing the GPU computing task on the second GPU thread based on the first data and the second data in response to that a data obtaining process of the first data and the data preloading process of the second data are completed includes: in response to that the data obtaining process of the first data and the data preloading process of the second data are completed, occupying the GPU computing lock on the second GPU thread, and executing the GPU computing based on the first data and the second data.

Optionally, in an example of the above-mentioned aspect, the GPU computing lock is implemented by allocating volatile integer space to the GPU global memory.

According to another aspect of the embodiments of this specification, a data processing method based on a GPU on-chip memory is provided, including: delivering, by a CPU device, a GPU computing task to a GPU device, and creating a first GPU thread for obtaining first data and a second GPU thread for preloading second data and performing GPU computing, where the first data include writable data needed by the GPU computing task, and the second data include read-only data that are needed by the GPU computing task and that are stored in a GPU global memory; initiating, by the GPU device, a data obtaining operation for the first data on the first GPU thread after the GPU computing task is started; when the first GPU thread performs the data obtaining operation, initiating, by the GPU device on the second GPU thread, a data preloading process of preloading the second data from the GPU global memory to the GPU on-chip memory; and executing, by the GPU device, the GPU computing task on the second GPU thread based on the first data and the second data in response to that a data obtaining process of the first data and the data preloading process of the second data are completed.

According to another aspect of the embodiments of this specification, a data processing apparatus based on a GPU on-chip memory is provided, including: a data obtaining unit, configured to initiate a data obtaining operation for first data on a first GPU thread, where the first data include writable data needed by a GPU computing task; a data preloading unit, configured to: when the first GPU thread performs the data obtaining operation, initiate, on a second GPU thread, a data preloading process of preloading second data from a GPU global memory to the GPU on-chip memory, where the second data include read-only data that are needed by the GPU computing task and that are stored in the GPU global memory; and a computing task execution unit, configured to execute the GPU computing task on the second GPU thread based on the first data and the second data in response to that a data obtaining process of the first data and the data preloading process of the second data are completed.

According to another aspect of the embodiments of this specification, a data processing system based on a GPU on-chip memory is provided, including: a CPU device, configured to: deliver a GPU computing task to a GPU device, and create a first GPU thread for obtaining first data and a second GPU thread for preloading second data and performing GPU computing, where the first data include writable data needed by the GPU computing task, and the second data include read-only data that are needed by the GPU computing task and that are stored in a GPU global memory; and the GPU device, including the above-mentioned data processing apparatus based on a GPU on-chip memory.

According to another aspect of the embodiments of this specification, a data processing apparatus based on a GPU on-chip memory is provided, including: at least one processor; a storage coupled to the at least one processor; and a computer program stored in the storage. The at least one processor executes the computer program to implement the above-mentioned data processing method based on a GPU on-chip memory.

According to another aspect of the embodiments of this specification, a data processing system based on a GPU on-chip memory is provided, including: at least one processor; a storage coupled to the at least one processor; and a computer program stored in the storage. The at least one processor executes the computer program to implement the above-mentioned data processing method based on a GPU on-chip memory.

According to another aspect of embodiments of this specification, a computer-readable storage medium is provided. The computer-readable storage medium stores executable instructions, and when the instructions are executed, a processor is enabled to perform the above-mentioned data processing method based on a GPU on-chip memory.

According to another aspect of embodiments of this specification, a computer program product is provided, including a computer program. The computer program is executed by a processor to implement the above-mentioned data processing method based on a GPU on-chip memory.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 is a diagram illustrating a performance comparison between GPU memories;

FIG. 2 is a schematic diagram illustrating a model structure of a GLM model;

FIG. 3 is a schematic diagram illustrating data transmission in a matrix multiplication operation;

FIG. 4 is a schematic diagram illustrating a principle of preloading to a GPU on-chip memory, according to an embodiment of this specification;

FIG. 5 is an example block diagram illustrating a data processing system, according to an embodiment of this specification;

FIG. 6 is an example flowchart illustrating a data processing method, according to an embodiment of this specification;

FIG. 7 is an example schematic diagram illustrating a preloading configuration file, according to an embodiment of this specification;

FIG. 8 is an example schematic diagram illustrating a data preloading process of an L2 cache, according to an embodiment of this specification;

FIG. 9 is an example block diagram illustrating a data processing apparatus based on an on-chip memory, according to an embodiment of this specification;

FIG. 10 is an example schematic diagram illustrating a data processing apparatus based on an on-chip memory that is implemented based on a computer system, according to an embodiment of this specification; and

FIG. 11 is an example schematic diagram illustrating a data processing system based on an on-chip memory that is implemented based on a computer system, according to an embodiment of this specification.

### DESCRIPTION OF EMBODIMENTS

The subject matters described in this specification are discussed below with reference to example implementations. It should be understood that the discussion of these implementations is merely intended to enable a person skilled in the art to better understand the subject matters described in this specification, and is not intended to limit the protection scope, applicability, or examples described in the claims. The functions and arrangements of the elements under discussion can be changed without departing from the protection scope of this specification. Various processes or components can be omitted, replaced, or added in various examples as needed. For example, the described method can be performed in a sequence different from the described sequence, and the steps can be added, omitted, or combined. In addition, the features described in some examples can also be combined in other examples.

As used in this specification, the term “include” and variants thereof represent an open term, which means “including but not limited to”. The term “based on” represents “at least partially based on”. The terms “one embodiment” and “an embodiment” represent “at least one embodiment”. The term “another embodiment” represents “at least one another embodiment”. The terms “first”, “second”, etc. can refer to different or identical objects. Other definitions, whether explicit or implicit, can be included below. Unless expressly specified in the context, the definition of a term is consistent throughout this specification.

A flowchart used in this specification illustrates operations implemented by a system according to some embodiments of this specification. It should be clearly understood that operations in the flowchart cannot be implemented in sequence. In contrast, the operations can be implemented in reverse order or simultaneously. In addition, one or more other operations can be added to the flowchart. One or more operations can be removed from the flowchart.

Before descriptions are provided, several concepts involved in the following embodiments of this specification are first described.

A graphics processing unit (GPU) is a microprocessor that performs image and graphics related operation work on a personal computer, a workstation, a game console, and some mobile devices (such as a tablet computer and a smartphone), can be used for graphics display and computing acceleration, and has a high-speed parallel computing capability. The GPU can also be referred to as a display core, a visual processor, a display chip, etc.

An internal storage of the GPU can be referred to as a GPU memory. To satisfy an application scenario of the GPU, the GPU memory include a GPU on-chip storage and a GPU off-chip storage based on a location of storage hardware. A common GPU on-chip storage includes a GPU shared memory, a GPU register, a GPU L1/L2 cache, etc. The GPU off-chip storage includes a GPU local memory and a GPU global memory.

A GPU memory bandwidth is a data transmission rate between a GPU computing unit and the GPU memory. Because hardware materials of the GPU on-chip storage and the GPU off-chip storage are different, a transmission speed from the GPU on-chip storage to the GPU computing unit is usually five to 10 times of a transmission speed from the GPU off-chip storage to the GPU computing unit. FIG. 1 is a diagram illustrating a performance comparison between GPU memories.

A streaming multiprocessor (SM) is a computing logic unit in a GPU, and is similar to a core in a multi-core CPU chip. A core of a CPU usually runs a thread, and the SM can run a plurality of threads (for example, a lightweight thread).

The GPU global memory can be accessed and globally shared by all threads in a GPU device, and have relatively large storage space. Like a CPU architecture, the GPU computing unit cannot directly use data in the GPU global memory, and a cache needs to be used. An L2 cache can be globally accessed by all SMs, and a quantity of bandwidths is a time of that of the GPU global memory. An L1 cache is configured to store data in the SM, and can be shared by an operation unit in the SM, but the L1 cache cannot be accessed across SMs.

The GPU shared memory is a memory that can be accessed in an operation block. An access speed of the GPU shared memory is significantly faster than that of the L2 cache. The GPU shared memory is mainly configured to cache data that need to be repeatedly read and written.

In a large model (for example, large language model) inference phase based on the GPU computing unit, especially when batch data of model feature data for model inference are relatively small, a performance bottleneck of model inference is not model computing, but a data loading time of loading, from the GPU global memory to the GPU computing unit, model parameter data (model weight matrices) for model computing. The following provides descriptions by using a GLM model as an example.

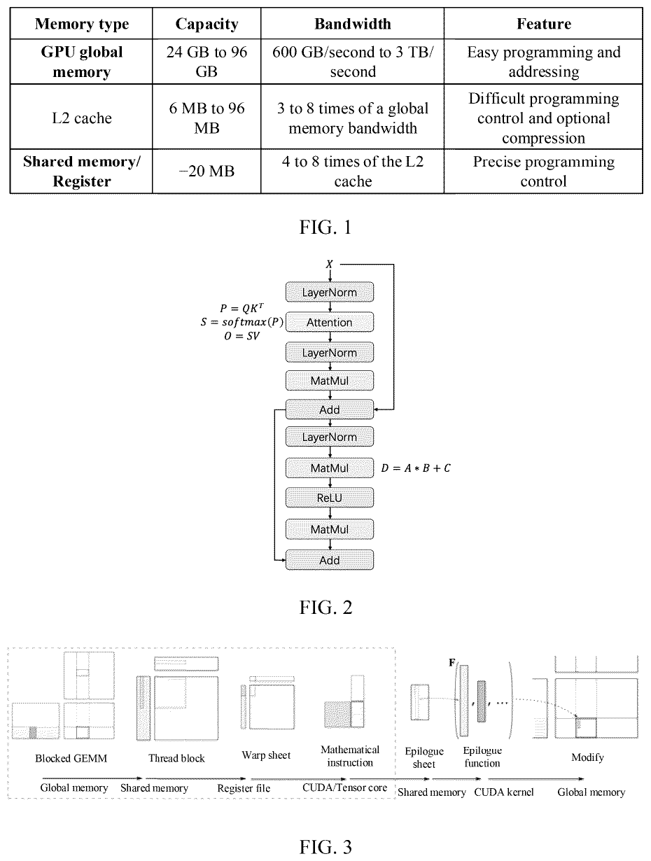

FIG. 2 is a schematic diagram illustrating a model structure of a GLM model.

As shown in FIG. 2, a large model structure of the GLM model includes a normalized layer (LayerNorm), an attention layer (Attention), and a multilayer sensing layer (MatMul). The attention layer is configured to perform a matrix multiplication operation. It can be learned from time consumption analysis of model computing that, a time consumption ratio of matrix multiplication is more than 50% in a model inference process.

Unlike a training process, after a model service goes online, when the matrix multiplication operation is performed in an inference phase, a size of an input depends on a size of instantaneous traffic. For the matrix multiplication operation of the GLM model, a matrix used for matrix multiplication includes a model feature matrix X and a model weight matrix Y. When batch data of model feature data are relatively small, the model feature matrix X is usually relatively small, and the model weight matrix Y is relatively large. A size of the model weight matrix Y is usually [hidden_states, 4*hidden_states]. A 10 B model commonly used in the industry is used as an example. hidden_states is 4096, and is stored based on float16. The size of the model weight matrix Y is 128 MB. The model feature matrix X is a variable matrix to which an input is performed in real time. A model weight parameter of the model weight matrix Y does not change after model training is completed. In other words, the model weight matrix is an invariable matrix, and the model weight matrix Y is stored in a GPU global memory of a GPU apparatus.

FIG. 3 is a schematic diagram illustrating data transmission in a matrix multiplication operation.

When the matrix multiplication operation is performed, an input is performed to a model feature matrix X in real time, and a model weight matrix Y is loaded from a GPU global memory to a GPU shared memory, and then from the GPU shared memory to a GPU register, and is loaded from the GPU register to a GPU computing unit, to perform matrix multiplication computing. It can be learned from the above-mentioned descriptions that time consumption of the matrix multiplication operation includes time consumption of loading data needed by the matrix multiplication operation and time consumption of matrix multiplication computing. As a computing capability of a GPU is continuously improved, the time consumption of matrix multiplication computing is far less than the time consumption of loading data needed by the matrix multiplication operation. The time consumption of loading data needed by the matrix multiplication operation includes time consumption of loading data of the model feature matrix X and time consumption of loading data of the model weight matrix Y. A data amount of the model feature matrix X is far less than a data amount of the model weight matrix Y, especially when batch data of model feature data are relatively small, so that a data loading time of loading the model weight matrix Y from the GPU global memory to the GPU computing unit is far greater than a data input time of the model feature matrix X. Consequently, the time consumption of matrix multiplication operation depends on a data loading time of the model weight matrix Y from the GPU global memory to the GPU computing unit.

In consideration that data used by a GPU computing task include variable data and read-only data, the variable data need to be input in real time, and the read-only data do not change and are stored in the GPU global memory, when GPU computing is performed, loading needs to be performed from the GPU global memory to the GPU computing unit. Embodiments of this specification provide a data processing method based on a GPU on-chip memory. In the data processing method, when a data loading operation of the GPU computing task is performed, two threads are started, and when a data obtaining operation of writable data is performed through one thread, the read-only data are preloaded from the GPU global memory to the GPU on-chip memory through the other thread, to shorten a data loading time of the read-only data during model computing based on a strong data access capability of the GPU on-chip memory, thereby improving an operation speed of GPU computing.

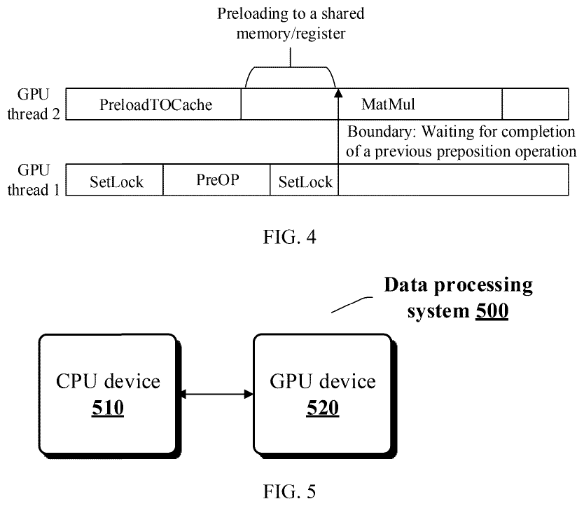

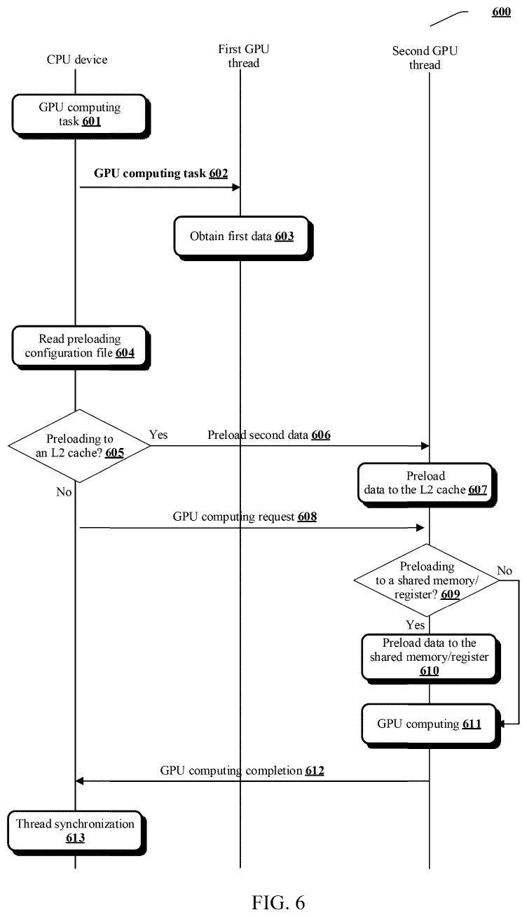

FIG. 4 is a schematic diagram illustrating a principle of preloading to a GPU on-chip memory, according to an embodiment of this specification.

As shown in FIG. 4, after a GPU computing task is received, a scheduling module in a CPU device creates a first GPU thread (GPU thread 1) and a second GPU thread (GPU thread 2) on a GPU device. Data used by the GPU computing task include writable data and read-only data. The writable data can be, for example, real-time input model feature data or other real-time data, the read-only data can include, for example, model weight data, and the read-only data are stored in a GPU global memory, and are preloaded from the GPU global memory to a GPU on-chip memory during GPU computing. The first GPU thread is configured to obtain the writable data (PreOP operation) needed by the GPU computing task, and the second GPU is configured to implement a preloading operation (for example, preloading to an L2 cache (PreloadTOCache) and preloading to a GPU shared memory/GPU register) of the read-only data from the GPU global memory to the GPU on-chip memory and a GPU computing operation. In addition, during execution on the first GPU thread, the preloading operation of the read-only data is performed on the second GPU thread.

The following describes in detail, with reference to the accompanying drawings, a data processing system and a data processing method that are based on a GPU on-chip memory according to the embodiments of this specification.

FIG. 5 is an example block diagram illustrating a data processing system 500, according to an embodiment of this specification. As shown in FIG. 5, the data processing system 500 includes a CPU device 510 and a GPU device 520.

The CPU device 510 is configured to allocate and schedule a GPU computing task. Data used during GPU computing in the scheduled GPU computing task include writable data and read-only data stored in a GPU global memory. For example, when model inference is performed based on a large model, the CPU device 510 can divide model computing in a to-be-executed model inference task into one or more GPU computing tasks, and schedule the GPU computing task to a GPU computing unit to perform GPU computing. In some embodiments, model computing can include, for example, matrix multiplication computing between a model feature matrix and a model weight matrix.

In response to that the GPU computing task is scheduled to the GPU device 520, a scheduling unit in the CPU device 510 creates a first GPU thread and a second GPU thread on the GPU device 520. The GPU device 520 obtains the writable data through the created first GPU thread under scheduling performed by the scheduling unit, and preloads the read-only data from the GPU global memory to a GPU on-chip memory through the second GPU thread when the first GPU thread obtains the writable data. After the second GPU thread completes a data obtaining operation of the writable data and a data preloading operation of the read-only data, the GPU device 520 performs GPU computing based on the writable data and the read-only data through the second GPU thread, to complete the GPU computing task.

FIG. 6 is an example flowchart illustrating a data processing method 600, according to an embodiment of this specification.

As shown in FIG. 6, in 601, a CPU device completes allocation of a GPU computing task, and in 602, schedules the GPU computing task to a corresponding GPU computing unit, to perform GPU computing, and creates a first GPU thread and a second GPU thread on a GPU device. The first GPU thread is configured to obtain writable data (referred to as first data below) needed by the GPU computing task, and the second GPU is configured to implement a preloading operation of preloading read-only data (referred to as second data below) needed by the GPU computing task from a GPU global memory to a GPU on-chip memory and a GPU computing operation. For example, in a model inference process, the GPU computing task can be a model computing task such as a matrix multiplication operation task, the writable data are input model feature matrix data, and the read-only data are model weight matrix data.

In 603, after the GPU computing task is received and GPU computing in the GPU computing task is started, the GPU device performs a first data obtaining operation on the first GPU thread, to obtain first data needed for GPU computing. In some embodiments, the first data obtaining operation can also be referred to as a preposition operation (PreOP) of GPU computing.

When the first GPU thread performs a data obtaining operation for the first data, the data preloading operation of preloading the second data from the GPU global memory to the GPU on-chip memory is initiated on the second GPU thread. In some embodiments, the GPU on-chip memory can include at least one of an L2 cache, a GPU shared memory, and a GPU register.

In some embodiments, whether the second data needed by the GPU computing task need to be preloaded from the GPU global memory to the GPU on-chip memory can be determined based on a preloading configuration file. The preloading configuration file is used to configure a specific GPU on-chip memory to which the data preloading operation is performed. In some embodiments, whether the second data needed by the GPU computing task need to be preloaded from the GPU global memory to the GPU on-chip memory can also be determined in another manner. For example, whether the second data needed by the GPU computing task need to be preloaded from the GPU global memory to the GPU on-chip memory is determined based on a remaining capacity space size of the GPU on-chip memory.

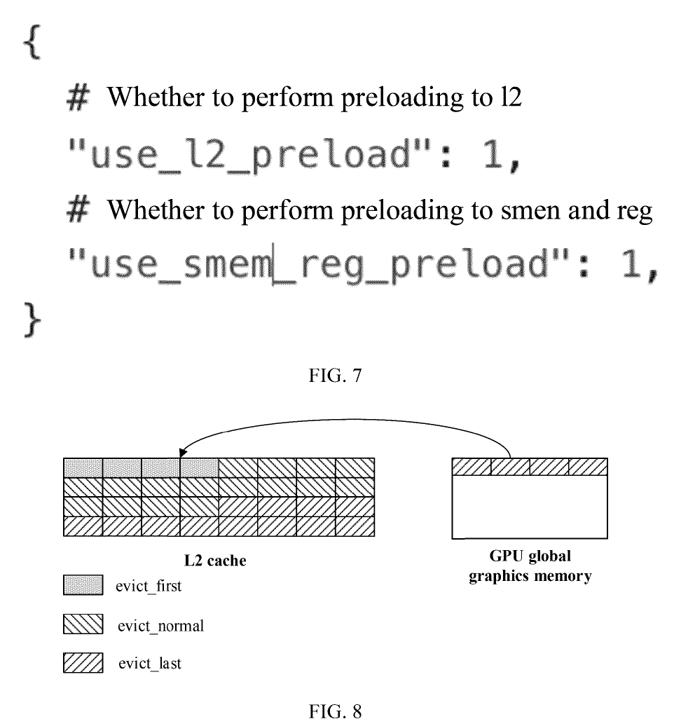

FIG. 7 is an example schematic diagram illustrating a preloading configuration file, according to an embodiment of this specification. In an example of the preloading configuration file shown in FIG. 7, the preloading configuration file has an L2 cache preloading identifier field “use_L2_preload” and a shared memory/register preloading identifier field “use_smem_reg_preload”. When a value of the fields is 0, it indicates that the preloading operation is not performed, and when a value of the fields is 1, it indicates that the preloading operation is performed. In the example in FIG. 7, values of “use_L2_preload” and “use_smem_reg_preload” are 1, to specify that a preloading operation from the GPU global memory to the L2 cache and a preloading operation from the GPU global memory to the GPU shared memory and the GPU register need to be performed.

Specifically, as shown in FIG. 6, when the GPU device obtains the first data on the first GPU thread, in 604, the CPU device loads the preloading configuration file. Then, whether the second data need to be preloaded from the GPU global memory to the GPU on-chip memory needs to be determined based on the preloading configuration file. In an example shown in FIG. 6, the GPU on-chip memory includes the L2 cache, the GPU shared memory, and the GPU register.

In 605, the CPU device determines, based on the preloading configuration file, whether the second data need to be preloaded from the GPU global memory to the L2 cache. After it is determined that the second data need to be preloaded from the GPU global memory to the L2 cache, in 606, the CPU device initiates a second data preloading request to the GPU device. The second data preloading request is used to request to preload the second data from the GPU global memory to the L2 cache.

In 607, after receiving the second data preloading request, the GPU device initiates, on the second GPU thread, a first data preloading process of preloading the second data from the GPU global memory to the L2 cache. Data preloaded in the first data preloading process can be some or all of the second data based on a data size of the second data and an available memory space size of the L2 cache. When the first data preloading process is executed, if the data size of the second data exceeds the available memory space size of the L2 cache, some of the second data are preloaded from the GPU global memory to the L2 cache. For example, if a memory capacity of the L2 cache is k MB and the size of the second data is (k+n) MB, some data whose size is k MB and that start from the first data of the second data are preloaded to the L2 cache, and remaining n MB data are not preloaded to the L2 cache. If the data size of the second data does not exceed the available memory space size of the L2 cache, all of the second data are preloaded from the GPU global memory to the L2 cache.

As shown in FIG. 3, before GPU computing is performed, data needed for GPU computing need to successively pass through the L2 cache and the L1 cache from the GPU global memory and arrive at the GPU computing unit. Affected by a GPU memory bandwidth, loading data from the GPU global memory is relative slow. Consequently, GPU computing is limited by a memory access speed, and performance is relatively poor. With continuous development of GPU technologies, the L2 cache of the GPU gradually increases. For example, a storage capacity of the latest L40S GPU of NVIDIA is 16 times greater than that of a previous-generation A10 L2 cache. Therefore, data preloading can be performed based on the L2 cache.

FIG. 8 is an example schematic diagram illustrating a data preloading process of an L2 cache, according to an embodiment of this specification.

As shown in FIG. 8, data in the GPU global memory are cached in the L2 cache in a form of a sector, and each sector has an eviction priority. For example, a GPU preloads the data from the GPU global memory through the second GPU thread, and the data are cached in the L2 cache in a form of 32 sectors. A cache row size of each L2 cache is four sectors, namely, 128 bytes. Each sector is provided with a tag (tag), to identify whether the sector is in the cache. When cache space is insufficient to store a new sector, a sector cached in the L2 cache is evicted. Each sector can be provided with an eviction priority, and the eviction priority includes one of evict_first, evict_last, or evict_normal. An eviction sequence of sectors is sequentially evict_first->evict_normal->evict_last. In some embodiments, for each sector, an initial eviction priority is set to evict_normal, the eviction priority changes to evict_last when cached data are the second data needed for GPU computing, and the eviction priority changes to evict_first when the cached data can be updated at any time or are independent of GPU computing.

When the second data are preloaded to the L2 cache, if free cache space of the L2 cache is insufficient to cache the second data, the sectors cached in the L2 cache are evicted based on eviction priorities of evict_first, evict_normal, and evict_last, until the free cache space of the L2 cache is sufficient to cache the second data.

When it is determined that the preloading operation from the GPU global memory to the L2 cache does not need to be performed, in 608, the CPU device initiates a GPU computing request to the GPU device. The GPU computing request is used to initiate the GPU computing operation on the second GPU thread.

In 609, when it is determined that the preloading operation from the GPU global memory to the L2 cache does not need to be performed or that the data preloaded in the first data preloading process are some of the second data, the GPU device determines, on the second GPU thread based on the preloading configuration file, whether the second data or remaining data of the second data need to be preloaded from the GPU global memory to the GPU shared memory and/or the GPU register. In some embodiments, after the GPU device completes the first data preloading process to the L2 cache, if the data preloaded in the data preloading process are some of the second data, the GPU device determines, on the second GPU thread based on the preloading configuration file, whether the remaining data of the second data need to be preloaded from the GPU global memory to the GPU shared memory and/or the GPU register. Alternatively, after receiving the GPU computing request initiated by the CPU device, the GPU device determines, on the second GPU thread based on the preloading configuration file, whether the second data need to be preloaded from the GPU global memory to the GPU shared memory and/or the GPU register.

When it is determined that the remaining data or all data of the second data need to be preloaded from the GPU global memory to the GPU shared memory and/or the GPU register, in 610, a second data preloading process of preloading the remaining data of the second data from the GPU global memory to the GPU shared memory and/or the GPU register is initiated on the second GPU thread, or a third data preloading process of preloading the second data (all the data) from the GPU global memory to the GPU shared memory and/or the GPU register is initiated on the second GPU thread. Here, whether data preloaded in the second data preloading process are some or all of the remaining data of the second data can be determined based on a data size of the remaining data and an available memory space size of the GPU shared memory and/or the GPU register. Similarly, data preloaded in the third data preloading process are some or all of the second data can be determined based on the data size of the second data and the available memory space size of the GPU shared memory and/or the GPU register.

It can be seen from FIG. 3 that, in addition to being transmitted to the GPU computing unit through the L1/L2 cache, data of a matrix multiplication operation can also be transmitted to the GPU computing unit through the GPU on-chip memory such as the GPU shared memory and the GPU register Because preloading to the L2 cache is transparent to a subsequent operation, subsequent execution logic does not need to be modified, but a disadvantage is that only an eviction priority of the L2 cache can be modified and precise data preloading control cannot be implemented. The GPU shared memory and the GPU register serve as programmable GPU on-chip memories. Precise data preloading control can be implemented by performing address programming on the GPU shared memory or the GPU register in a data preloading process (for example, a memory address of preloaded data or a to-be-stored memory address is programmed).

Each SM of the GPU device has a fixed quantity of GPU shared memories and GPU registers. L40 is used as an example. There are 144 SMs, and each SM has a 64 KB GPU shared memory and 64 KB GPU register. If 128 SMs are used, and the 64 KB GPU shared memory and the 64 KB GPU register are used on each SM, 16 MB data can be preloaded.

After data preloading from the GPU global memory to the GPU on-chip memory is completed, for example, after data preloading from the GPU global memory to the GPU shared memory and/or the GPU register is completed or it is determined that data preloading from the GPU global memory to the GPU shared memory and/or the GPU register does not need to be performed, in 611, the GPU computing task is performed on the second GPU thread based on the first data and the second data. It should be noted that if data preloaded from the GPU global memory to the GPU on-chip memory are all of the second data, the second data are loaded from the GPU on-chip memory to the GPU computing unit during GPU computing. Subsequently, the GPU computing unit executes the GPU computing task based on the first data and the second data. If the data preloaded from the GPU global memory to the GPU on-chip memory are not all of the second data, during GPU computing, some of the preloaded second data are loaded from the GPU on-chip memory to the GPU computing unit, and some data that are not preloaded in the second data are loaded from the GPU global memory to the GPU computing unit. Subsequently, the GPU computing unit executes the GPU computing task based on the first data and the second data.

After GPU computing is completed, in 612, the GPU device returns a GPU computing completion message to the CPU device, for example, returns a GPU computing result. Subsequently, in 613, the CPU device performs thread synchronization on the first GPU thread and the second GPU thread, so that the GPU computing task is processed.

In some embodiments, to ensure that the first data are obtained before GPU computing in the GPU computing task is performed, a GPU computing lock can be allocated for GPU computing. The GPU computing lock is used to control an enable operation of GPU computing on the GPU device. In some embodiments, the GPU computing lock is implemented by allocating volatile integer space to the GPU global memory. For example, when a value of the CPU computing lock is 0, it indicates that the GPU computing lock is idle. Therefore, the GPU computing operation can be performed. When the value of the CPU computing lock is 1, it indicates that the GPU computing lock is occupied. In this case, the GPU computing operation cannot be performed.

During obtaining of the first data, the GPU device can obtain and occupy the GPU computing lock on the first GPU thread. For example, an initial value of the GPU computing lock can be set to 0. After the first GPU thread obtains the GPU computing lock, the value of the GPU computing lock changes to 1. After the first data obtaining operation is completed, the GPU device can release the GPU computing lock on the first GPU thread. For example, the value of the GPU computing lock is set from 1 to 0, so that the GPU computing lock changes to an idle state.

In addition, in response to that the data obtaining process of the first data and the data preloading process of the second data are completed, the GPU computing lock is obtained and occupied on the second GPU thread.

For example, after data loading is completed, the SM continuously queries the value of the GPU computing lock. If the value of the GPU computing lock changes to 0, the GPU computing lock is obtained, and the value of the GPU computing lock is set to 1, to occupy the GPU computing lock.

It should be noted that, in the example in FIG. 6, it is disclosed that whether the second data need to be preloaded from the GPU global memory to the GPU on-chip memory is determined based on the preloading configuration file. However, in another embodiment, it can be unnecessary to use the above-mentioned preloading determining process based on the preloading configuration file. In other words, provided that the second data needed for GPU computing exist in the GPU global memory, the preloading process of preloading the second data from the GPU global memory to the GPU on-chip memory is performed.

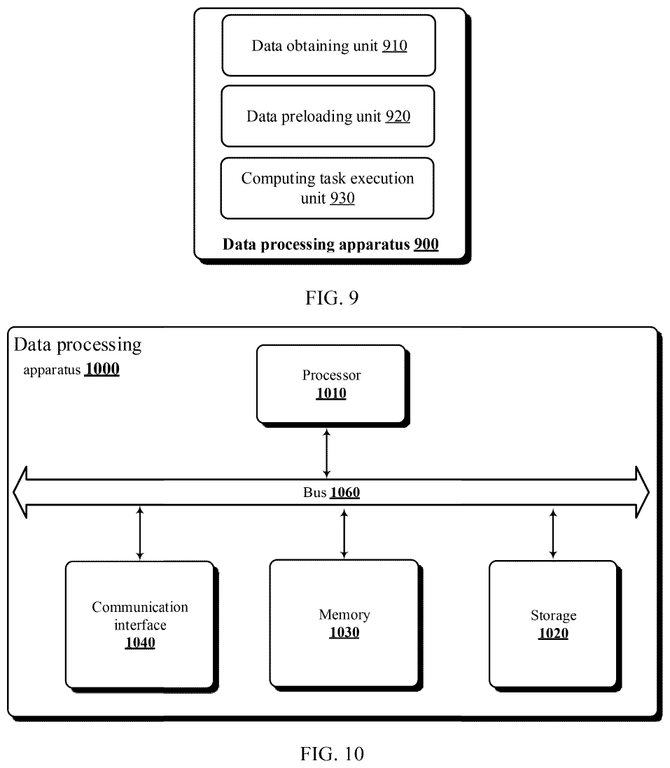

FIG. 9 is an example block diagram illustrating a data processing apparatus 900 based on an on-chip memory, according to an embodiment of this specification. As shown in FIG. 9, the data processing apparatus 900 includes a data obtaining unit 910, a data preloading unit 920, and a computing task execution unit 930.

The data obtaining unit 910 is configured to initiate a data obtaining operation for first data on a first GPU thread. The first data include writable data needed by a GPU computing task.

The data preloading unit 920 is configured to: when the first GPU thread performs the data obtaining operation, initiate, on a second GPU thread, a data preloading process of preloading second data from a GPU global memory to the GPU on-chip memory. The second data include read-only data that are needed by the GPU computing task and that are stored in the GPU global memory. In some embodiments, whether the second data need to be preloaded from the GPU global memory to the GPU on-chip memory can be determined based on a preloading configuration file.

In some embodiments, in response to that the second data need to be preloaded from the GPU global memory to an L2 cache, the data preloading unit 920 initiates, on the second GPU thread, a first data preloading process of preloading the second data (for example, some or all data) from the GPU global memory to the L2 cache.

When data preloaded in the first data preloading process are some of the second data, whether remaining data of the second data need to be preloaded from the GPU global memory to the GPU shared memory and/or the GPU register can be determined. For example, whether the remaining data of the second data need to be preloaded from the GPU global memory to the GPU shared memory and/or the GPU register can be determined based on the preloading configuration file. In response to that the remaining data of the second data need to be preloaded from the GPU global memory to the GPU shared memory and/or the GPU register, the data preloading unit 920 initiates, on the second GPU thread, a second data preloading process of preloading the remaining data (for example, some or all data) of the second data from the GPU global memory to the GPU shared memory and/or the GPU register.

When the second data do not need to be preloaded from the GPU global memory to the L2 cache, whether the second data need to be preloaded from the GPU global memory to the GPU shared memory and/or the GPU register can be determined. For example, whether the second data need to be preloaded from the GPU global memory to the GPU shared memory and/or the GPU register can be determined based on the preloading configuration file. In response to that the second data need to be preloaded from the GPU global memory to the GPU shared memory and/or the GPU register, the data preloading unit 920 initiates, on the second GPU thread, a third data preloading process of preloading the second data (for example, some or all data) from the GPU global memory to the GPU shared memory and/or the GPU register.

In response to that data preloading of the second data is completed and a GPU computing lock is successfully obtained on the second GPU thread, the computing task execution unit 930 executes the GPU computing task on the second GPU thread based on the first data and the second data.

The data processing method, the data processing apparatus, and the data processing system that are based on a GPU on-chip memory according to the embodiments of this specification are described above with reference to FIG. 1 to FIG. 9. The data processing apparatus and the data processing system can be implemented by using hardware, or can be implemented by using software or a combination of hardware and software.

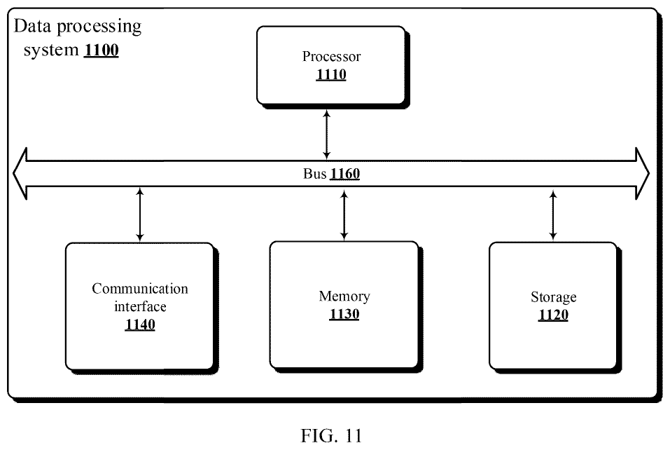

FIG. 10 is an example schematic diagram illustrating a data processing apparatus 1000 based on a GPU on-chip memory that is implemented based on a computer system, according to an embodiment of this specification. As shown in FIG. 10, the data processing apparatus 1000 can include at least one processor 1010, a storage (for example, a nonvolatile memory) 1020, a memory 1030, and a communication interface 1040, and the at least one processor 1010, the storage 1020, the memory 1030, and the communication interface 1040 are connected together through a bus 1060. The at least one processor 1010 executes at least one computer-readable instruction (namely, the above-mentioned elements implemented in a software form) stored or encoded in the storage.

In an embodiment, the storage stores computer-executable instructions, and when the computer-executable instructions are executed, the at least one processor 1010 is enabled to perform the following operations: initiating a data obtaining operation for first data on a first GPU thread, where the first data include writable data needed by a GPU computing task; when the first GPU thread performs the data obtaining operation, initiating, on a second GPU thread, a data preloading process of preloading second data from a GPU global memory to the GPU on-chip memory, where the second data include read-only data that are needed by the GPU computing task and that are stored in the GPU global memory; and executing the GPU computing task on the second GPU thread based on the first data and the second data in response to that a data obtaining process of the first data and the data preloading process of the second data are completed.

It should be understood that, when the computer-executable instructions stored in the storage are executed, the at least one processor 1010 is enabled to perform the above-mentioned operations and functions described with reference to FIG. 1 to FIG. 9 in the embodiments of this specification.

FIG. 11 is an example schematic diagram illustrating a data processing system 1100 based on a GPU on-chip memory that is implemented based on a computer system, according to an embodiment of this specification. As shown in FIG. 11, the data processing system 1100 can include at least one processor 1110, a storage (for example, a nonvolatile memory) 1120, a memory 1130, and a communication interface 1140, and the at least one processor 1110, the storage 1120, the memory 1130, and the communication interface 1140 are connected together through a bus 1160. The at least one processor 1110 executes at least one computer-readable instruction (namely, the above-mentioned elements implemented in a software form) stored or encoded in the storage.

In an embodiment, the storage stores computer-executable instructions, and when the computer-executable instructions are executed, the at least one processor 1110 is enabled to perform the following operations: delivering, by a CPU device, a GPU computing task to a GPU device, and creating a first GPU thread for obtaining first data and a second GPU thread for preloading second data and performing GPU computing, where the first data include writable data needed by the GPU computing task, and the second data include read-only data that are needed by the GPU computing task and that are stored in a GPU global memory; initiating, by the GPU device, a data obtaining operation for the first data on the first GPU thread after the GPU computing task is started; when the first GPU thread performs the data obtaining operation, initiating, by the GPU device on the second GPU thread, a data preloading process of preloading the second data from the GPU global memory to the GPU on-chip memory; and executing, by the GPU device, the GPU computing task on the second GPU thread based on the first data and the second data in response to that a data obtaining process of the first data and the data preloading process of the second data are completed.

It should be understood that, when the computer-executable instructions stored in the storage are executed, the at least one processor 1110 is enabled to perform the above-mentioned operations and functions described with reference to FIG. 1 to FIG. 9 in the embodiments of this specification.

According to an embodiment, a program product such as a machine-readable medium (for example, a non-transient machine-readable medium) is provided. The machine-readable medium can have instructions (to be specific, the above-mentioned element implemented in a software form). When the instruction is executed by a machine, the machine is enabled to perform the above-mentioned operations and functions described with reference to FIG. 1 to FIG. 9 in the embodiments of this specification. Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instruction stored in the readable storage medium.

In such a case, the program code read from the readable medium can implement the functions in any one of some embodiments described above, and therefore the machine-readable code and the readable storage medium storing the machine-readable code form a part of this application.

Embodiments of the readable storage medium include a floppy disk, a hard disk, a magneto-optical disk, an optical disc (for example, a CD-ROM, a CD-R, a CD-RW, a DVD-ROM, a DVD-RAM, a DVD-RW, and a DVD-RW), a magnetic tape, a nonvolatile memory card, and a ROM. Alternatively, the program code can be downloaded from a server computer or a cloud by a communication network.

According to one or more embodiments, a computer program product is provided. The computer program product includes a computer program, and when the computer program is executed by a processor, the processor is enabled to perform the above-mentioned operations and functions described with reference to FIG. 1 to FIG. 9 in the embodiments of this specification.

A person skilled in the art should understand that various variations and modifications can be made to embodiments disclosed above without departing from the essence of this specification. Therefore, the protection scope of this specification should be defined by the appended claims.

It should be noted that, not all the steps and units in the above-mentioned processes and system structure diagrams are necessary, and some steps or units can be ignored based on an actual need. An order of performing the steps is not fixed, and can be determined based on a need. The apparatus structure described in the above-mentioned embodiments can be a physical structure or a logical structure. In other words, some units can be implemented by the same physical entity, or some units can be implemented by a plurality of physical entities, or can be implemented together by some components in a plurality of independent devices.

In the above-mentioned embodiments, a hardware unit or module can be implemented mechanically or electrically. For example, a hardware unit, a module, or a processor can include a permanent dedicated circuit or logic (such as a dedicated processor, FPGA, or ASIC) to complete a corresponding operation. The hardware unit or the processor can further include a programmable logic or circuit (such as a general-purpose processor or another programmable processor), and can be set temporarily by software to complete a corresponding operation. Specific implementations (mechanical methods, dedicated permanent circuits, or temporarily disposed circuits) can be determined based on cost and time considerations.

The specific implementations illustrated above with reference to the accompanying drawings describe example embodiments, but do not represent all embodiments that can be implemented or fall within the protection scope of the claims. The term “example” used throughout this specification means “used as an example, an instance, or an illustration”, but does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

The foregoing descriptions of the present disclosure are provided to enable any person of ordinary skill in the art to implement or use the present disclosure. Various modifications made to the present disclosure are apparent to a person of ordinary skill in the art, and the general principles defined in this specification can also be applied to other variants without departing from the protection scope of the present disclosure. Therefore, the present disclosure is not limited to the examples and designs described in this specification, but corresponds to the widest scope of principles and novel features disclosed in this specification.

What is claimed is:

1. A method for data processing based on a graphics processing unit (GPU) on-chip memory, comprising:
initiating a data obtaining operation for first data on a first GPU thread, wherein the first data comprise writable data needed by a GPU computing task;
when the first GPU thread performs the data obtaining operation, initiating, on a second GPU thread, a data preloading process of preloading second data from a GPU global memory to a GPU on-chip memory, wherein the second data comprise read-only data that are needed by the GPU computing task and that are stored in the GPU global memory; and
in response to that a data obtaining process of the first data and the data preloading process of the second data are completed, executing the GPU computing task on the second GPU thread based on the first data and the second data.

2. The method according to claim 1, further comprising:
determining, based on a preloading configuration file, whether to initiate the data preloading process of preloading the second data from the GPU global memory to the GPU on-chip memory.

3. The method according to claim 1, wherein the GPU on-chip memory comprises an L2 cache; and
the initiating, on a second GPU thread, a data preloading process of preloading second data from a GPU global memory to the GPU on-chip memory comprises:
initiating, on the second GPU thread, a first data preloading process of preloading the second data from the GPU global memory to the L2 cache.

4. The method according to claim 3, wherein the GPU on-chip memory further comprises a GPU shared memory and a GPU register, and the initiating, on a second GPU thread, a data preloading process of preloading second data from a GPU global memory to the GPU on-chip memory further comprises:
when data preloaded in the first data preloading process are a part of the second data, initiating, on the second GPU thread, a second data preloading process of preloading remaining data from the GPU global memory to at least one of the GPU shared memory or the GPU register.

5. The method according to claim 3, wherein the GPU on-chip memory further comprises a GPU shared memory and a GPU register, and the initiating, on a second GPU thread, a data preloading process of preloading second data from a GPU global memory to the GPU on-chip memory further comprises:
when the first data preloading process does not need to be executed, initiating, on the second GPU thread, a third data preloading process of preloading the second data from the GPU global memory to at least one of the GPU shared memory or the GPU register.

6. The method according to claim 3, wherein data stored in the L2 cache are cached in a form of a sector, and each sector has an eviction priority.

7. The method according to claim 6, wherein the eviction priority comprises one of evict_first, evict_normal, or evict_last, and the method further comprises:
after the second data are preloaded to the L2 cache, setting, to evict_last, an eviction priority of a sector that caches the second data.

8. The method according to claim 7, further comprising:
when the second data are preloaded to the L2 cache, and free cache space of the L2 cache is insufficient to cache the second data, evicting sectors cached in the L2 cache based on eviction priorities of evict_first, evict_normal, and evict_last, until the free cache space of the L2 cache is sufficient to cache the preloaded second data.

9. The method according to claim 1, wherein the GPU computing task comprises a model computing task of a model inference process, the first data comprise model feature data, and the second data comprise model parameter data.

10. The method according to claim 1, wherein a GPU computing lock is allocated for the GPU computing task, and the method further comprises:
occupying the GPU computing lock on the first GPU thread during data obtaining of the first data, and releasing the GPU computing lock on the first GPU thread after data obtaining of the first data is completed; and
the executing the GPU computing task on the second GPU thread based on the first data and the second data in response to that a data obtaining process of the first data and the data preloading process of the second data are completed comprises:
in response to that the data obtaining process of the first data and the data preloading process of the second data are completed, occupying the GPU computing lock on the second GPU thread, and executing the GPU computing based on the first data and the second data.

11. The method according to claim 10, wherein the GPU computing lock is implemented by allocating volatile integer space to the GPU global memory.

12. A method for data processing based on a graphics processing unit (GPU) on-chip memory, comprising:
delivering, by a central processing unit (CPU) device, a GPU computing task to a GPU device; and
creating, by the CPU device, a first GPU thread for obtaining first data and a second GPU thread for preloading second data and performing GPU computing, wherein the first data comprise writable data needed by the GPU computing task, and the second data comprise read-only data that are needed by the GPU computing task and that are stored in a GPU global memory;
initiating, by the GPU device, a data obtaining operation for the first data on the first GPU thread after the GPU computing task is started;
when the first GPU thread performs the data obtaining operation, initiating, by the GPU device on the second GPU thread, a data preloading process of preloading the second data from the GPU global memory to a GPU on-chip memory; and
in response to that a data obtaining process of the first data and the data preloading process of the second data are completed, executing, by the GPU device, the GPU computing task on the second GPU thread based on the first data and the second data.

13. A computer-implemented device, comprising:
one or more processors; and
one or more tangible, non-transitory, machine-readable media storing one or more instructions that, when executed by the one or more processors, perform one or more operations comprising:
initiating a data obtaining operation for first data on a first GPU thread, wherein the first data comprise writable data needed by a GPU computing task;
when the first GPU thread performs the data obtaining operation, initiating, on a second GPU thread, a data preloading process of preloading second data from a GPU global memory to a GPU on-chip memory, wherein the second data comprise read-only data that are needed by the GPU computing task and that are stored in the GPU global memory; and
in response to that a data obtaining process of the first data and the data preloading process of the second data are completed, executing the GPU computing task on the second GPU thread based on the first data and the second data.

14. The computer-implemented device according to claim 13, wherein the one or more operations further comprise:
determining, based on a preloading configuration file, whether to initiate the data preloading process of preloading the second data from the GPU global memory to the GPU on-chip memory.

15. The computer-implemented device according to claim 13, wherein the GPU on-chip memory comprises an L2 cache; and
the initiating, on a second GPU thread, a data preloading process of preloading second data from a GPU global memory to the GPU on-chip memory comprises:
initiating, on the second GPU thread, a first data preloading process of preloading the second data from the GPU global memory to the L2 cache.

16. The computer-implemented device according to claim 13, wherein the GPU computing task comprises a model computing task of a model inference process, the first data comprise model feature data, and the second data comprise model parameter data.

17. The computer-implemented device according to claim 13, wherein a GPU computing lock is allocated for the GPU computing task, and the one or more operations further comprise:
occupying the GPU computing lock on the first GPU thread during data obtaining of the first data, and releasing the GPU computing lock on the first GPU thread after data obtaining of the first data is completed; and
the executing the GPU computing task on the second GPU thread based on the first data and the second data in response to that a data obtaining process of the first data and the data preloading process of the second data are completed comprises:
in response to that the data obtaining process of the first data and the data preloading process of the second data are completed, occupying the GPU computing lock on the second GPU thread, and executing the GPU computing task based on the first data and the second data.

18. A data processing system, comprising:
a central processing unit (CPU) device configured to:
deliver a GPU computing task to a GPU device; and
create a first GPU thread for obtaining first data and a second GPU thread for preloading second data and performing GPU computing, wherein the first data comprise writable data needed by the GPU computing task, and the second data comprise read-only data that are needed by the GPU computing task and that are stored in a GPU global memory; and
the GPU device configured to:
initiate a data obtaining operation for the first data on the first GPU thread after the GPU computing task is started;
when the first GPU thread performs the data obtaining operation, initiate, on a second GPU thread, a data preloading process of preloading second data from a GPU global memory to a GPU on-chip memory, wherein the second data comprise read-only data that are needed by the GPU computing task and that are stored in the GPU global memory; and
in response to that a data obtaining process of the first data and the data preloading process of the second data are completed, execute the GPU computing task on the second GPU thread based on the first data and the second data.

19. The data processing system according to claim 18, wherein the GPU device configured to:
determine, based on a preloading configuration file, whether to initiate the data preloading process of preloading the second data from the GPU global memory to the GPU on-chip memory.

20. The data processing system according to claim 18, wherein the GPU on-chip memory comprises an L2 cache; and the GPU device configured to:
initiate, on the second GPU thread, a first data preloading process of preloading the second data from the GPU global memory to the L2 cache.
